(19) United States
(12) Patent Application Publication
(10) Pub. No.: US 2025/0139857 A1
(43) Pub. Date: May 1, 2025

(54) NEURAL NETWORK-BASED ANTI-ALIASING FOR HAIR RENDERING

(71) Applicant: Tencent America LLC, Palo Alto, CA (US)

(72) Inventors: Rundong WU, Mountain View, CA (US); Bo YANG, Los Angeles, CA (US)

(73) Assignees: Tencent America LLC, Palo Alto, CA (US); Tencent America LLC, Palo Alto, CA (US)

(21) Appl. No.: 18/386,147

(22) Filed: Nov. 1, 2023

(51) Int. Cl. G06T 11/40; G06T 3/40; G06T 11/00

(52) U.S. Cl. CPC G06T 11/40; G06T 3/4053; G06T 11/001; G06T 2210/62

(57) ABSTRACT

A method of hair rendering includes acquiring a color input image and an opacity input image from a hair rendering system, the color input image and the opacity input image having a first sample resolution. The method further includes providing the color input image and the opacity input image as input to a trained neural network configured to generate an intermediate color output image and an intermediate opacity output image by performing an anti-aliasing function on the color input image and the opacity input image. The method further includes performing hair rendering based on the intermediate color output image and the intermediate opacity output image to generate a final rendered hair image.

### TECHNICAL FIELD

The present disclosure describes aspects generally related to rendering hair in various applications.

### BACKGROUND

The background description provided herein is for the purpose of generally presenting the context of the disclosure. Work of the presently named inventor, to the extent the work is described in this background section, as well as aspects of the description that may not otherwise qualify as prior art at the time of filing, are neither expressly nor impliedly admitted as prior art against the present disclosure.

The past few decades have seen remarkable advances in creating realistic visual effects for computer animations and games. However, to enable a more fully immersive experience for these computer-generated environments, it is also important to realistically render complex objects, such as hair. Because hair is composed of individual strands that may look and move differently from each other, capturing complex and dynamic hair structures in a more realistic way would improve visual realism and fidelity of hair representations in various video applications, including gaming and animation.

### SUMMARY

Aspects of the disclosure include methods, apparatuses, and non-transitory computer-readable storage mediums for hair rendering. In some examples, an apparatus for hair rendering includes processing circuitry.

According to an aspect of the disclosure, a method of hair rendering is provided. The method includes acquiring a color input image and an opacity input image from a hair rendering system, the color input image and the opacity input image having a first sample resolution. The method further includes providing the color input image and the opacity input image as input to a trained neural network configured to generate an intermediate color output image and an intermediate opacity output image by performing an anti-aliasing function on the color input image and the opacity input image. The method further includes performing hair rendering based on the intermediate color output image and the intermediate opacity output image to generate a final rendered hair image.

In an aspect, the trained neural network is trained using training images having a second sample resolution that is greater than the first sample resolution.

In an aspect, the first sample resolution is 1 sample per pixel, the second sample resolution is n samples per pixel, where n is an integer greater than 1, and each sample represents a ray cast toward a pixel corresponding to the respective sample.

In an aspect, the method further includes providing, as input to the trained neural network, a previous intermediate color output image and a previous intermediate opacity output image output by the trained neural network for a previous frame. In this aspect, the trained neural network generates the intermediate color output image and the intermediate opacity output image for a current frame based on (i) the color input image and the opacity input image acquired for the current frame and (ii) the previous intermediate color output image and the previous intermediate opacity output image output by the trained neural network for the previous frame.

In an aspect, the method further includes performing deferred hair rendering by, during rendering of a current frame, providing a color input image and an opacity input image corresponding to a prior frame preceding the current frame to the trained neural network. In this aspect, the deferred hair rendering further includes, in response to the trained neural network outputting an intermediate color output image and an intermediate opacity output image corresponding to the prior frame, generating the current frame by combining non-hair rendered components of the current frame with a final rendered hair image based on the intermediate color output image and the intermediate opacity output image corresponding to the prior frame.

In an aspect, the performing the deferred hair rendering further includes, during rendering of the current frame, generating a color input image and an opacity input image corresponding to the current frame. In this aspect, the generated color input image and opacity input image corresponding to the current frame are provided to the trained neural network during rendering of a next frame after the current frame. In an aspect, the color input image, the opacity input image, the intermediate color output image, and the intermediate opacity output image include only hair.

According to another aspect of the disclosure, an apparatus is provided. The apparatus has processing circuitry. The processing circuitry can be configured to perform any one or a combination of hair rendering.

Aspects of the disclosure also provide a non-transitory computer-readable medium storing instructions which when executed by at least one processor cause the at least one processor to perform any one or a combination of the methods for hair rendering.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary hair rendering system.

FIG. 2 is a schematic illustration of an exemplary hair rendering system using a neural network to generate intermediate results in accordance with some aspects.

FIG. 3A is a schematic illustration of an exemplary neural network architecture for hair rendering in accordance with some aspects.

FIG. 3B is a schematic illustration of an exemplary residual block sequence included in a neural network in accordance with some aspects.

FIGS. 4A and 4B are timeline illustrations of the timing of a hair anti-aliasing function with other rendering functions in accordance with some aspects.

FIG. 5 shows a flow chart outlining an exemplary process for hair rendering according to some aspects of the disclosure.

FIG. 6 is a schematic illustration of a computer system in accordance with an aspect.

### DETAILED DESCRIPTION

In the present disclosure, AA can stand for anti-aliasing. Anti-aliasing is a technique used in video rendering. The output of video rendering is an image shown on a screen, which is composed of a discrete grid of pixels. In order to determine the values of the pixels to be displayed, the rendered video is spatially sampled. As the frames of the video are sequentially shown on the screen, the displayed video becomes distorted if the spatial sampling rate of the pixels is insufficient to capture the details of the video.

Such distortion is known as aliasing. For applications that rely on video rendering, like games, a common aliasing phenomenon often looks like jagged shapes along the edges of objects. Aliasing may affect, for example, first person shooter (FPS) games, third person shooter (TPS), role playing games (RPG) and virtual reality (VR) games, among others. Aliasing may also affect other real-time applications, especially applications that involve hair rendering. The function of anti-aliasing refers to techniques used to remove aliasing artifacts, thereby improving visual quality.

The present disclosure introduces a novel neural network-based approach to an anti-aliasing function for hair rendering. Specifically, the disclosed neural network-based approach employs a neural network to generate higher-quality intermediate results, such as an intermediate color image and an intermediate opacity image, for hair strands in real-time hair rendering. The solution provided in the present disclosure captures complex and dynamic hair structures at an intermediate point in the hair rendering pipeline, thereby achieving a significant improvement in hair rendering quality. As a result, the present disclosure resolves the persistent artifact of jagged edges and blurriness in rendered hair in various applications to enhance visual realism, most notably in gaming and animation.

In a related example, a spatial anti-aliasing technique known as Multi-sample Anti-aliasing (MSAA) involves super-sampling such that multiple locations are sampled within every pixel and each of those samples is fully rendered and combined with the other to produce the displayed pixel. The related example of MSAA is essentially a brute force approach that increases the spatial sampling rate for all or part of a frame to reduce aliasing, at a high computational cost.

Additionally, MSAA includes a trade-off between effectiveness and speed since the higher computational load leads to slower rendering speeds. In real-time applications, MSAA is often applied only to the depth channel rather than the color channel to reduce computation. Generally, achieving satisfactory anti-aliasing without impacting the real-time frame rate using MSAA remains challenging.

Another related example used in gaming is temporal anti-aliasing (TAA), which is a spatial anti-aliasing technique that combines information from past frames and the current frame to achieve a super-sampling effect with lower computational cost. That is, TAA involves merely blending and accumulating previous frames' rendering results to achieve an anti-aliasing effect, which lowers computational cost as compared to MSAA. However, a disadvantage of TAA is that, in dynamic scenes, pixel values vary widely and reusing pixel samples from previous frames leads to ghosting and blurring artifacts.

Finally, other related anti-aliasing techniques include Deep Learning Super Sampling (DLSS) and deep learning anti-aliasing (DLAA). DLAA is similar to TAA in that they are both anti-aliasing solutions using past frame data. On the other hand, DLSS is a technique that allows graphics to be rendered at a lower resolution for improved performance and then a higher resolution image is inferred to approximate the details of the higher resolution image without having to render it.

Both DLSS and DLAA achieve their respective results using neural networks. However, neural networks are used in DLSS and DLAA either to exclude unreasonable samples and blend samples from prior frames or to generate final image data. Neither DLSS nor DLAA employs neural networks to generate high-quality intermediate hair images, as disclosed herein.

Other related examples of simulating and rendering include methods where hair strands are mapped onto a mesh, then simulated and rendered using the generated mesh. However, this approach lacks precision in accurately depicting individual dynamics of hair strands.

Additionally, hair physics simulators may be available within game engines, such as Unreal Engine, for hair rendering and simulation. However, the hair images rendered by such related game engine systems yield subpar anti-aliasing results due to the fine geometric structure of hair strands. The anti-aliasing method disclosed herein may operate in combination with game engine systems to improve visual results by providing a more successful anti-aliasing effect.

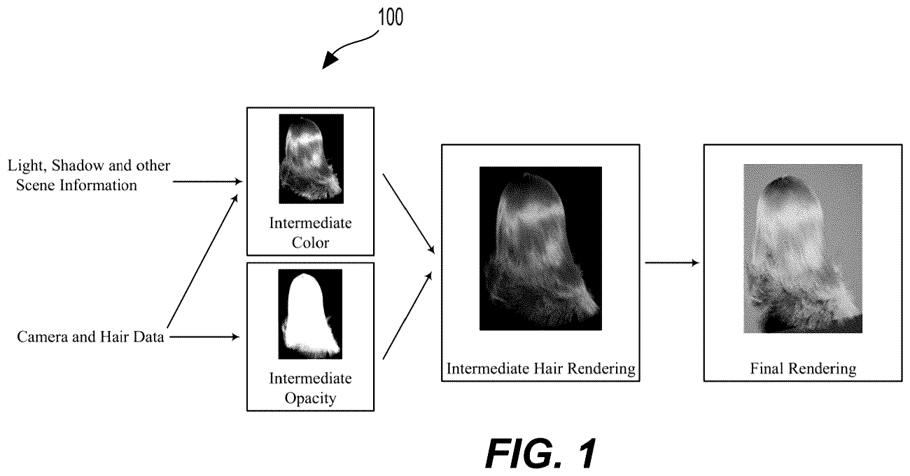

FIG. 1 is a schematic illustration of an exemplary hair rendering system. The hair rendering system shown in FIG. 1 represents the methodology used for hair rendering in game engines such as Unreal Engine (UE). For example, in UE, a Groom system may calculate various intermediate images that combine to render hair.

As shown in FIG. 1, the Groom system may take as input factors such as camera data, hair data, as well as light, shadow, and other scene information. Based on the factors, the Groom system may generate intermediate images 100, such as an intermediate color image and an intermediate opacity image. The intermediate images 100 (the intermediate color image and the intermediate opacity image) are then combined to obtain an intermediate hair rendering, which is in turn combined with other frame elements to generate a final rendered image.

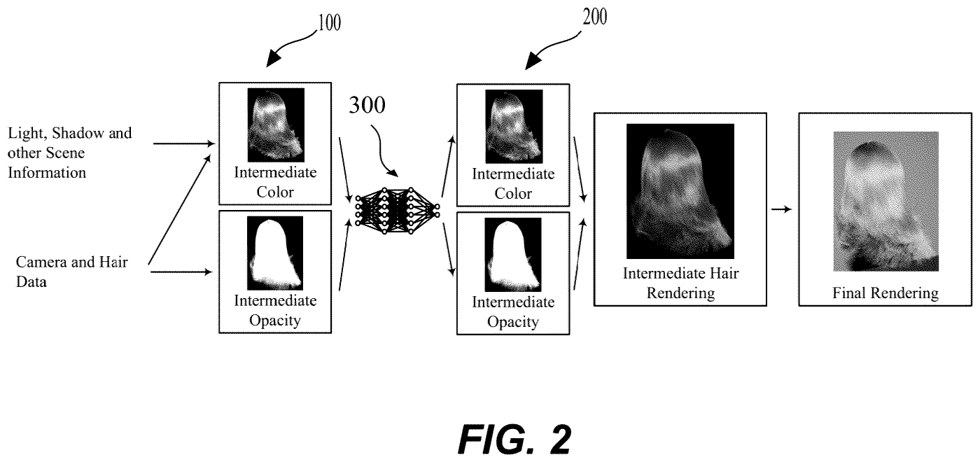

However, final rendering results generated by the exemplary system shown in FIG. 1 may be of poor visual quality when sample rate is low and the intermediate color and opacity images include noise and aliasing. Accordingly, the present disclosure is directed to an improvement of the exemplary system shown in FIG. 1 using a neural network-based approach. In the disclosed approach, the neural network generates high-quality intermediate results for the color image and the opacity image simultaneously, enabling synthesis of high-quality hair rendering results, as shown in FIG. 2.

FIG. 2 is a schematic illustration of an exemplary hair rendering system using a neural network 300 to generate intermediate results in accordance with some aspects. Specifically, the aspect shown in FIG. 2 uses the intermediate images 100 generated by a gaming engine, as described above with respect to FIG. 1. However, instead of combining the intermediate images 100 to arrive at the intermediate hair rendering image, the aspect of FIG. 2 further refines the intermediate images 100 generated by the gaming engine to improve quality prior to combining the intermediate images.

On an abstract level, aspects of the present disclosure, as shown in FIG. 2, convert lower-quality intermediate images 100 generated by the game engine into higher-quality intermediate images 200, similarly to an image-to-image super-resolution task. However, aspects of the present disclosure do not require generation of higher resolution images, but instead generate higher quality images with the same resolution.

In FIG. 2, intermediate images 100, for example an intermediate color image and an intermediate opacity image generated by a game engine such as Unreal Engine, are input into a neural network 300, which generates higher-quality intermediate images 200, for example a higher quality intermediate color image and a higher quality intermediate opacity image. Next, the higher-quality intermediate images 200 are combined to generate an intermediate hair image and a final rendered image that includes the intermediate hair image and image elements.

The additional step of inputting the intermediate images 100 generated by the game engine into a neural network 300 that generates higher-quality intermediate images 200 provides an anti-aliasing function that improves the visual quality of the final rendering image. While the exemplary aspects described herein describe the input and output of the neural network 300 as images, the input and output format of the neural network 300 may be other data formats, as long as such data formats may be converted from and to the format used by the rendering pipeline.

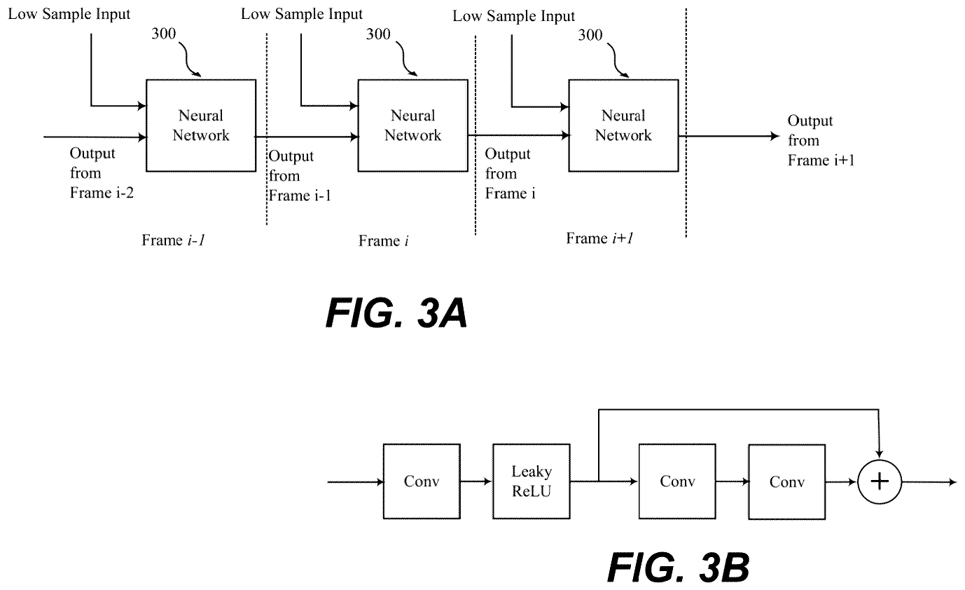

Operation of the neural network 300 is shown in FIG. 3A. To process each frame, the input to the neural network 300 includes (1) a low sample input image generated by the rendering pipeline and (2) the output of the neural network 300 for the previous frame. The low sample input image (1) may be, for example, intermediate images 100 generated by a game engine such as Unreal Engine. Use of the neural network output from the previous frame (2) ensures consistency between frames, which reduces temporal flickering.

While FIG. 3A shows the output of the neural network 300 for a given frame being fed back into the neural network 300 for processing of the next frame, the output of the neural network 300 for each frame is also output to the rendering pipeline to generate a final rendering image. That is, as shown in FIG. 2, the output of the neural network 300 for each frame is intermediate images 200 such as a color output image and an opacity output image, which are returned to the rendering pipeline to be combined into an intermediate hair image, which is then included in a final rendered image.

FIG. 3B shows an exemplary block of the neural network 300. The neural network 300 may include one or more blocks, such as the block of FIG. 3B. The block of FIG. 3B includes three convolution layers and one rectifier, or rectified linear unit labeled “Leaky ReLU.” In the example of FIG. 3B, the rectified linear unit has a leaky property, which provides a small positive gradient when the unit is not active. However, other linear unit variants may be used. Additionally, more or fewer than three convolutional layers may be connected and other layer types may also be included in the neural network 300, such as dense layers, pooling layers, recurrent layers, and/or normalization layers. The network topology of the neural network 300 is not limited to the exemplary aspect of FIG. 3B and other various topologies may be used to construct the system according to the present disclosure.

While the topology configuration of the neural network 300 may correspond to the exemplary aspect of FIG. 3B or another layer configuration, the training of the neural network 300 is also an important part of neural network configuration. Training a neural network demands a substantial amount of high-quality data. In the field of rendering, a sample refers to sub-pixel information that is generated by tracing a ray from a camera position toward a corresponding sample point (or pixel) of the image.

The number of samples per rendered pixel has a great impact on image quality. However, the time budget associated with real-time rendering usually only allows for one sample per pixel, which leads to noise and aliasing. This is yet another reason that the intermediate hair images 100 generated by the game engine in FIG. 1 are not of high quality. Aspects of the present disclosure therefore feed the low-quality intermediate hair images 100 to the neural network 300, which generates high-quality intermediate images 200. While the exemplary aspects described below define the input images of the neural network 300 as having one sample per pixel, other sampling rates may be used. For example, the input images of the neural network 300 may have two or three or n samples per pixel, where n is a positive integer.

In any case, the high-quality intermediate images 200 output by the network 300 have the same pixel resolution as the input intermediate images 100, so the improvement in quality is not due to an increase in the number of pixels. Instead, the training of the neural network 300 includes inputting a first set of training images with one sample per pixel, and using a second set of training images having more than one sample per pixel as the ground truth for output. For example, the second set of training images may have 128 samples per pixel. The first set of training images (i.e., the input training images) may have more than one sample per pixel, and the second set of training images (i.e., the ground truth) would have a greater sample resolution than the input training images in any case.

Using the first and second sets of training images, the neural network learns to modify the first set of training images having one sample per pixel into a higher-quality set of output images using the second set of training images having more than one sample per pixel as the ground truth. That is, the second set of training images having more than one sample per pixel is used to define the loss function during training of the neural network 300.

In other words, the neural network 300 learns to improve the visual quality of images that have one sample per pixel so that they look more like images that have more than one sample per pixel. The trained neural network 300 modifies the input images to improve quality based on the 128 sample/pixel images (i.e., ground truth training images) used to train the neural network, for example.

All training images may be images of hair to focus the performance of the neural network 300 specifically on an anti-aliasing in rendered hair images. To cover various usage scenarios, a range of hairstyles, hair colors, and lighting conditions are employed during the training phase of the neural network 300. Additionally, various motion states are simulated using physics-based simulation to generate sequences of images under different movement scenarios, the sequences of images being used for training the neural network 300. A portion of the generated training images are used for testing and validation of the neural network 300 to achieve a desired accuracy.

Next, parameters of the neural network 300 trained specifically for anti-aliasing in rendered hair images may be optimized for deploying the neural network 300 into the overall real-time rendering application. Current gaming applications typically require frame rates of 30-60 frames per second or even higher, and, due to the presence of other rendering tasks, the computation time budget for a specific effect (such as anti-aliasing in rendered hair) is usually limited to a maximum of about 3 ms.

In light of such timing constraints, various optimizations are needed to ensure that aspects of hair anti-aliasing of this disclosure meet the requirements of real-time applications. For example, a network size may be selected to be as small as possible to reduce computational load. Additionally, float16 numerical precision may be used during deployment of the neural network 300, while float32 precision may be used during training. Reducing the numerical precision in this way may meet the timing requirements of real-time rendering without significantly affecting the anti-aliasing effect. Other numerical precisions may be used for the neural network 300, such as int8, depending on speed and quality requirements of the rendering system.

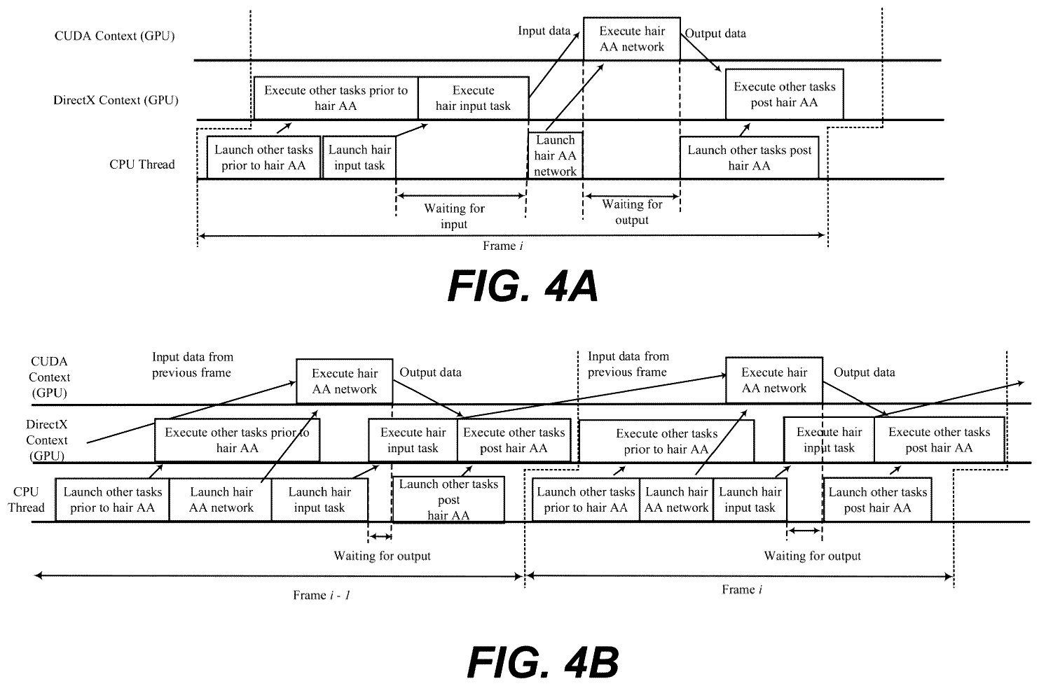

Another challenge in deploying the neural network in the real-time rendering pipeline is synchronizing the input/output of the neural network 300 with the rendering pipeline. FIGS. 4A and 4B show two approaches to such synchronization. As described above with respect to FIG. 2, the input to the neural network 300 is generated by the game engine rendering pipeline, which corresponds to the DirectX Context (GPU) timeline in the examples of FIGS. 4A and 4B. The output of the neural network 300 is returned to the game engine rendering pipeline for subsequent rendering of the full frame.

In the exemplary aspects shown in FIGS. 4A and 4B, the neural network 300 performs the anti-aliasing hair rendering functions using a different computing platform than the game engine rendering. Accordingly, FIGS. 4A and 4B show the hair anti-aliasing (AA) network function on a timeline labeled CUDA Context, while other rendering tasks are on the timeline labeled DirectX Context. However, various computing platforms may be used for the other rendering tasks and the hair AA network function and/or the other rendering tasks and the hair AA network function may be executed on the same computing platform or different computing platforms. If the other rendering tasks and the hair AA network function are executed on the same computing platform, the two GPU timelines in both FIGS. 4A and 4B would be consolidated onto a single timeline.

In FIGS. 4A and 4B, the CPU Thread timeline shows launching of the other rendering tasks (“Launch other tasks prior to hair AA” and “Launch other tasks post hair AA”), launching of the function to generate input to the AA network (“Launch hair input task”), and launching of the anti-aliasing function (“Launch hair AA network”). In FIG. 4A, the CPU Thread first launches other tasks to be completed in the rendering pipeline (DirectX Context, in the aspect of FIG. 4A) before the hair images to be input to the anti-aliasing function (e.g., intermediate images 100) may be generated.

Once the rendering pipeline reaches a point when the input hair images may be generated, the CPU Thread launches the hair input task in the rendering pipeline to generate the intermediate images 100 that will be the input to the AA network function. Then, a period of time passes while the hair input task is executed (i.e., while the rendering pipeline prepares the intermediate images 100 for input into the neural network 300). This period of time is labeled as “Waiting for input” in FIG. 4A and represents an added delay to the rendering process to accommodate the hair anti-aliasing function.

Once the hair input task is completed in the rendering pipeline (i.e., in the DirectX Context) and the intermediate images 100 are ready for input into the hair AA network (i.e., the neural network 300), a command from the CPU Thread to launch the hair AA network is sent to the computing platform on which the hair AA network operates. In the exemplary aspect of FIG. 4A, the hair AA network operates in the CUDA Context. At this time, the intermediate images 100 that were generated by the rendering pipeline are provided to the hair AA network (labeled as “input data” in FIG. 4A) for processing.

After the hair AA network described in the present disclosure is launched, a period of time elapses while the hair AA network processes the intermediate images 100 to generate higher-quality intermediate images 200. The period of time during which the hair AA network processes the intermediate images is labeled as “Waiting for output” in FIG. 4A. In addition to the “Waiting for input” time period, the “Waiting for output” time period is also an added delay to the rendering process to accommodate the hair anti-aliasing function.

Once the hair AA network generates the higher-quality intermediate images 200, these are sent as “output data” back to the general rendering pipeline, which executes other tasks post hair AA to finish rendering the frame, in FIG. 4A. FIG. 4A shows processing of a single frame (Frame i) and highlights the additional time that may be added to the frame rendering process as part of performing the disclosed hair AA functions. That is, the aspect of FIG. 4A may introduce a timing bottleneck into the rendering pipeline where the “waiting for input” and “waiting for output” time periods slow down overall frame rendering.

If the added time introduced by the “waiting for input” and “waiting for output” time periods introduced by the aspect of FIG. 4A is not compatible with the timing requirements of a real-time application, FIG. 4B shows an alternative, deferred synchronization method to decrease the time added to the processing of each frame to perform the hair AA function. The aspect of FIG. 4B, as compared to the aspect of FIG. 4A, removes the timing dependency between the steps of generating the input images in the rendering pipeline and then executing the hair anti-aliasing function. This resolves the timing bottleneck that may result from the aspect of FIG. 4A.

Specifically, the aspect of FIG. 4B generates input images for a particular frame during the rendering process of that frame, but executes the hair AA function in a subsequent frame. That is, in FIG. 4B, the execution of the hair AA network is delayed or deferred by one frame. For example, during rendering processing of frame i−1 in the aspect of FIG. 4B, the CPU Thread first launches other tasks to be completed in the rendering pipeline (DirectX Context, in the aspect of FIG. 4B).

Then, the CPU Thread launches the hair AA network in the CUDA context in the aspect of FIG. 4B. That is, the hair input task that was performed at this stage in the aspect of FIG. 4A is skipped in the aspect of FIG. 4B because input data to the hair AA network is provided from a previous frame. This aspect of the deferred synchronization method creates a more parallel processing structure between the hair AA function and the rendering pipeline (i.e., DirectX Context in the aspect of FIG. 4B) and removes the timing dependencies and potential speed bottleneck between the hair AA function and the rest of the rendering pipeline.

Next, in the aspect of FIG. 4B, the CPU Thread launches the hair input task to generate input intermediate images 100 corresponding to the frame i−1 to prepare these images for processing in the subsequent frame (frame i). After the hair AA network finishes processing the input images provided from the previous frame, the output data of the hair AA network is provided back to the rendering pipeline to be incorporated into the rest of frame i−1. At this point other tasks that are to be performed after the hair AA function are performed and rendering of frame i−1 is complete. Next, rendering of frame i begins and, when the hair AA function is launched during processing of frame i, the input intermediate images 100 corresponding to frame i−1 and generated during rendering of frame i-l are provided as input data to the AA network.

In frame i of the aspect of FIG. 4B, the hair AA network processes intermediate images 100 (i.e., input data) generated by the rendering pipeline in frame i−1. The high-quality intermediate images 200 generated by the hair AA network based on the input data from frame i−1 are output into the rendering pipeline in frame i. Meanwhile, new input data is prepared in frame i, which to be processed by the hair AA network in frame i+1.

While the deferred synchronization aspect of FIG. 4B introduces a one-frame delay in the rendered hair as opposed to the rest of the rendered image, the time delay of rendering each frame in this configuration is substantially decreased, as compared to the aspect of FIG. 4A. As shown in FIG. 4B, the only additional delay introduced by the hair AA function is a “Waiting for output” period that requires the hair AA network to finish processing the hair image from the previous frame before executing other tasks to finish rendering the frame based on the output of the hair AA function (i.e., “Execute other tasks post hair AA” in the DirectX Context of the aspect of FIG. 4B). For example, these other tasks may include combining the intermediate images output from the AA network with non-hair rendered components to generate the final rendered image.

Accordingly, the one-frame delay introduced in the aspect of FIG. 4B creates a sufficiently long interval between input data generation and neural network execution, thereby significantly reducing the waiting time before running the neural network 300 (i.e., the hair AA function). Other deferred timing configurations different from the example of FIG. 4B may be used, as long a sufficient interval is introduced to allow for the hair AA network to operate without introducing an impermissibly high delay into the rendering pipeline. Additionally, the various processing tasks of the aspects of FIGS. 4A and 4B may be performed in a different order or with different timing. For example, in the aspect of FIG. 4B, the rendering pipeline may execute the hair input task earlier or later during the rendering process of each frame, since the output of the hair input task is not used until the rendering of the following frame.

One implementation of the deferred synchronization aspect of FIG. 4B resulted in the hair AA function taking approximately 2.1 ms, whereas a frame rate for a simple hair rendering scene could exceed 100 frames per second. However, in certain deployment scenarios, the reduced waiting time afforded by the deferred synchronization aspect shown in FIG. 4B may not be necessary and the non-deferred aspect of FIG. 4A may be used.

Table 1 below shows a quantitative comparison between the disclosed hair AA function and some of the related methods described above.

TABLE 1

| | PSNR | SSIM |
|---|---|---|
| TAA | 31.64 | 0.9805 |
| DLAA | 32.69 | 0.9796 |
| Disclosed hair AA function | 33.43 | 0.9864 |

As shown in Table 1, the neural network-based hair AA function of the present disclosure yields a higher peak signal-to-noise ratio (PSNR) and a higher structural similarity index measure (SSIM) than TAA and DLAA, described above as related anti-aliasing methods.

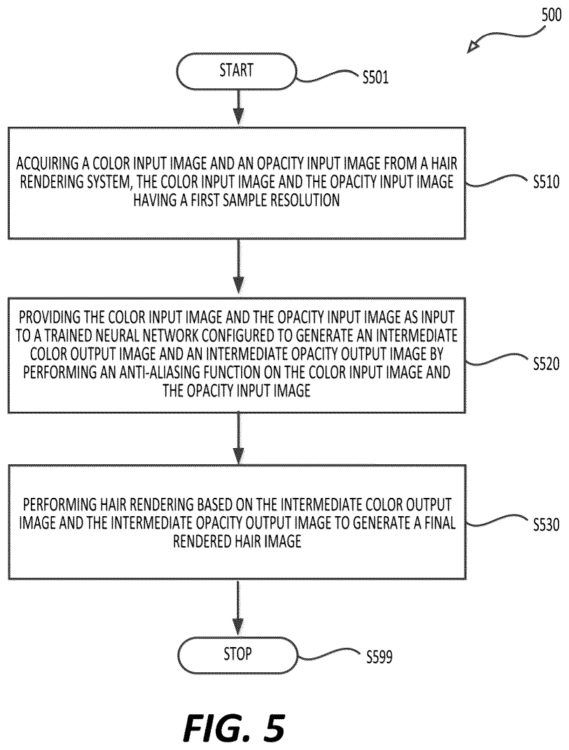

FIG. 5 shows a flow chart outlining a process (500) for hair rendering according to an aspect of the disclosure. The process starts at (S501) and proceeds to (S510).

At (S510), a color input image and an opacity input image are acquired from a hair rendering system. The color input image and the opacity input image both have a first sample resolution.

In an example, the first sample resolution is one sample per pixel, where the sample represents a ray cast toward a pixel corresponding to the respective sample. The color input image and the opacity input image may be generated by Unreal Engine. For example, the color input image and the opacity input image may correspond to intermediate images 100 in FIG. 2.

At (S520), the color input image and the opacity input image are provided as input to a trained neural network configured to generate an intermediate color output image and an intermediate opacity output image. The intermediate color output image and the intermediate opacity output image have a same pixel resolution as the color input image and the opacity input image but have an improved image quality.

In an example, the intermediate color output image and the intermediate opacity output image correspond to higher-quality intermediate images 200 and the trained neural network corresponds to the neural network 300 in FIG. 2. In an aspect, the trained neural network is trained using training images having a second sample resolution that is greater than the first sample resolution. The second sample resolution may be n samples per pixel, where n is 128 or another positive integer.

In an example, a previous intermediate color output image and a previous intermediate opacity output image output by the trained neural network for a previous frame are provided as input to the trained neural network for generating the intermediate color output image and the intermediate opacity output image for a current frame. In this aspect, the trained neural network generates the intermediate color output image and the intermediate opacity output image for a current frame based on (i) the color input image and the opacity input image acquired for the current frame and (ii) the previous intermediate color output image and the previous intermediate opacity output image output by the trained neural network for the previous frame. The color input image, the opacity input image, the intermediate color output image, and the intermediate opacity output image may all include only hair.

At (S530), hair rendering is performed based on the intermediate color output image and the intermediate opacity output image to generate a final rendered hair image.

In an example, the hair rendering is performed such that the final rendered hair image for frame (i−1) is integrated into a next frame i.

Then, the process proceeds to (S599) and terminates.

The process (500) can be suitably adapted. Step(s) in the process (500) can be modified and/or omitted. Additional step(s) can be added. Any suitable order of implementation can be used.

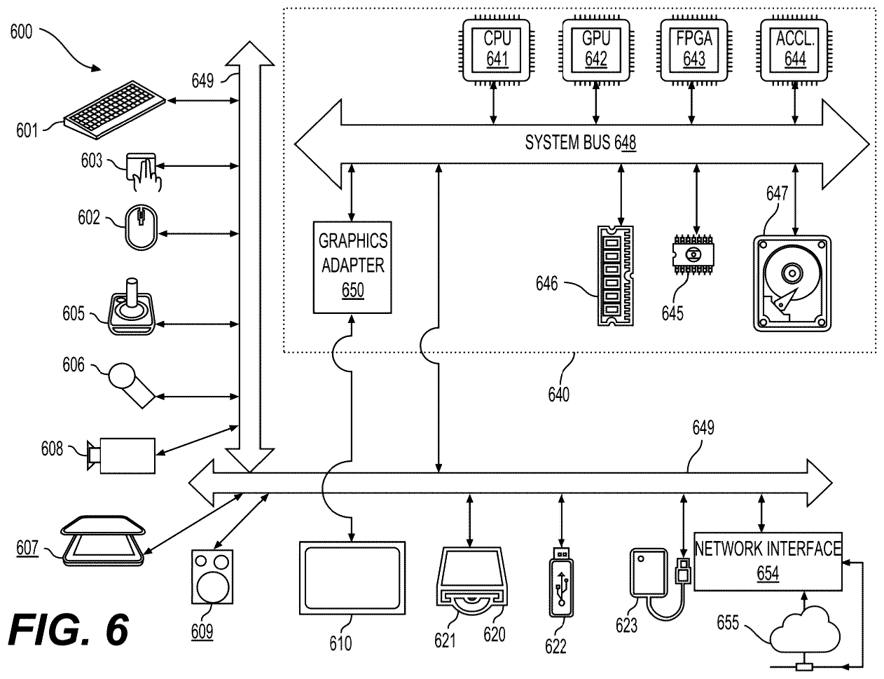

The techniques described above, can be implemented as computer software using computer-readable instructions and physically stored in one or more non-transitory computer-readable media. For example, FIG. 6 shows a computer system (600) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 6 for computer system (600) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (600).

Computer system (600) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (601), mouse (602), trackpad (603), touch screen (610), data-glove (not shown), joystick (605), microphone (606), scanner (607), camera (608).

Computer system (600) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (610), data-glove (not shown), or joystick (605), but there can also be tactile feedback devices that do not serve as input devices), audio output devices (such as: speakers (609), headphones (not depicted)), visual output devices (such as screens (610) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (600) can also include human accessible storage devices and their associated media such as optical media including CD/DVD ROM/RW (620) with CD/DVD or the like media (621), thumb-drive (622), removable hard drive or solid state drive (623), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (600) can also include an interface (654) to one or more communication networks (655). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (649) (such as, for example USB ports of the computer system (600)); others are commonly integrated into the core of the computer system (600) by attachment to a system bus as described below (for example Ethernet interface into a PC computer system or cellular network interface into a smartphone computer system). Using any of these networks, computer system (600) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (640) of the computer system (600).

The core (640) can include one or more Central Processing Units (CPU) (641), Graphics Processing Units (GPU) (642), specialized programmable processing units in the form of Field Programmable Gate Areas (FPGA) (643), hardware accelerators for certain tasks (644), graphics adapters (650), and so forth. These devices, along with Read-only memory (ROM) (645), Random-access memory (646), internal mass storage such as internal non-user accessible hard drives, SSDs, and the like (647), may be connected through a system bus (648). In some computer systems, the system bus (648) can be accessible in the form of one or more physical plugs to enable extensions by additional CPUs, GPU, and the like. The peripheral devices can be attached either directly to the core's system bus (648), or through a peripheral bus (649). In an example, the screen (610) can be connected to the graphics adapter (650). Architectures for a peripheral bus include PCI, USB, and the like.

CPUs (641), GPUs (642), FPGAs (643), and accelerators (644) can execute certain instructions that, in combination, can make up the aforementioned computer code. That computer code can be stored in ROM (645) or RAM (646). Transitional data can also be stored in RAM (646), whereas permanent data can be stored for example, in the internal mass storage (647). Fast storage and retrieve to any of the memory devices can be enabled through the use of cache memory, that can be closely associated with one or more CPU (641), GPU (642), mass storage (647), ROM (645), RAM (646), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (600), and specifically the core (640) can provide functionality as a result of processor(s) (including CPUs, GPUs, FPGA, accelerators, processing circuitry, and the like) executing software embodied in one or more tangible, computer-readable media. Such computer-readable media can be media associated with user-accessible mass storage as introduced above, as well as certain storage of the core (640) that are of non-transitory nature, such as core-internal mass storage (647) or ROM (645). The software implementing various embodiments of the present disclosure can be stored in such devices and executed by core (640). A computer-readable medium can include one or more memory devices or chips, according to particular needs. The software can cause the core (640) and specifically the processors therein (including CPU, GPU, FPGA, and the like) to execute particular processes or particular parts of particular processes described herein, including defining data structures stored in RAM (646) and modifying such data structures according to the processes defined by the software. In addition or as an alternative, the computer system can provide functionality as a result of logic hardwired or otherwise embodied in a circuit (for example: accelerator (644)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for hair rendering, the method comprising:
acquiring a color input image and an opacity input image from a hair rendering system, the color input image and the opacity input image having a first sample resolution;
providing the color input image and the opacity input image as input to a trained neural network configured to generate an intermediate color output image and an intermediate opacity output image by performing an anti-aliasing function on the color input image and the opacity input image; and
performing hair rendering based on the intermediate color output image and the intermediate opacity output image to generate a final rendered hair image.

2. The method according to claim 1, wherein the trained neural network is trained using training images having a second sample resolution that is greater than the first sample resolution.

3. The method according to claim 2, wherein
the first sample resolution is 1 sample per pixel,
the second sample resolution is n samples per pixel, where n is an integer greater than 1, and
each sample represents a ray cast toward a pixel corresponding to the respective sample.

4. The method according to claim 1, further comprising providing, as input to the trained neural network, a previous intermediate color output image and a previous intermediate opacity output image output by the trained neural network for a previous frame,
wherein the trained neural network generates the intermediate color output image and the intermediate opacity output image for a current frame based on (i) the color input image and the opacity input image acquired for the current frame and (ii) the previous intermediate color output image and the previous intermediate opacity output image output by the trained neural network for the previous frame.

5. The method according to claim 1, further comprising:
performing deferred hair rendering by
during rendering of a current frame, providing a color input image and an opacity input image corresponding to a prior frame preceding the current frame to the trained neural network; and
in response to the trained neural network outputting an intermediate color output image and an intermediate opacity output image corresponding to the prior frame, generating the current frame by combining non-hair rendered components of the current frame with a final rendered hair image based on the intermediate color output image and the intermediate opacity output image corresponding to the prior frame.

6. The method according to claim 5, wherein
the performing the deferred hair rendering further comprises, during rendering of the current frame, generating a color input image and an opacity input image corresponding to the current frame, and
the generated color input image and opacity input image corresponding to the current frame are provided to the trained neural network during rendering of a next frame after the current frame.

7. The method according to claim 1, wherein the color input image, the opacity input image, the intermediate color output image, and the intermediate opacity output image include only hair.

8. An apparatus for hair rendering, the apparatus comprising:
processing circuitry configured to
acquire a color input image and an opacity input image from a hair rendering system, the color input image and the opacity input image having a first sample resolution;
provide the color input image and the opacity input image as input to a trained neural network configured to generate an intermediate color output image and an intermediate opacity output image by performing an anti-aliasing function on the color input image and the opacity input image; and
perform hair rendering based on the intermediate color output image and the intermediate opacity output image to generate a final rendered hair image.

9. The apparatus according to claim 8, wherein the trained neural network is trained using training images having a second sample resolution that is greater than the first sample resolution.

10. The apparatus according to claim 9, wherein
the first sample resolution is 1 sample per pixel,
the second sample resolution is n samples per pixel, where n is an integer greater than 1, and
each sample represents a ray cast toward a pixel corresponding to the respective sample.

11. The apparatus according to claim 8, wherein the processing circuitry is further configured to provide, as input to the trained neural network, a previous intermediate color output image and a previous intermediate opacity output image output by the trained neural network for a previous frame,
wherein the trained neural network generates the intermediate color output image and the intermediate opacity output image for a current frame based on (i) the color input image and the opacity input image acquired for the current frame and (ii) the previous intermediate color output image and the previous intermediate opacity output image output by the trained neural network for the previous frame.

12. The apparatus according to claim 8, wherein the processing circuitry is further configured to perform deferred hair rendering by
during rendering of a current frame, providing a color input image and an opacity input image corresponding to a prior frame preceding the current frame to the trained neural network; and
in response to the trained neural network outputting an intermediate color output image and an intermediate opacity output image corresponding to the prior frame, generating the current frame by combining non-hair rendered components of the current frame with a final rendered hair image based on the intermediate color output image and the intermediate opacity output image corresponding to the prior frame.

13. The apparatus according to claim 12, wherein
the processing circuitry is further configured to, during rendering of the current frame, generate a color input image and an opacity input image corresponding to the current frame, and
the generated color input image and opacity input image corresponding to the current frame are provided to the trained neural network during rendering of a next frame after the current frame.

14. The apparatus according to claim 8, wherein the color input image, the opacity input image, the intermediate color output image, and the intermediate opacity output image include only hair.

15. A non-transitory computer-readable storage medium storing computer-readable instructions thereon, which, when executed by processing circuitry, cause the processing circuitry to perform a method for hair rendering, the method comprising:
acquiring a color input image and an opacity input image from a hair rendering system, the color input image and the opacity input image having a first sample resolution;
providing the color input image and the opacity input image as input to a trained neural network configured to generate an intermediate color output image and an intermediate opacity output image by performing an anti-aliasing function on the color input image and the opacity input image; and
performing hair rendering based on the intermediate color output image and the intermediate opacity output image to generate a final rendered hair image.

16. The non-transitory computer-readable storage medium according to claim 15, wherein the trained neural network is trained using training images having a second sample resolution that is greater than the first sample resolution.

17. The non-transitory computer-readable storage medium according to claim 16, wherein
the first sample resolution is 1 sample per pixel,
the second sample resolution is n samples per pixel, where n is an integer greater than 1, and
each sample represents a ray cast toward a pixel corresponding to the respective sample.

18. The non-transitory computer-readable storage medium according to claim 15, further comprising providing, as input to the trained neural network, a previous intermediate color output image and a previous intermediate opacity output image output by the trained neural network for a previous frame,
wherein the trained neural network generates the intermediate color output image and the intermediate opacity output image for a current frame based on (i) the color input image and the opacity input image acquired for the current frame and (ii) the previous intermediate color output image and the previous intermediate opacity output image output by the trained neural network for the previous frame.

19. The non-transitory computer-readable storage medium according to claim 15, further comprising:
performing deferred hair rendering by
during rendering of a current frame, providing a color input image and an opacity input image corresponding to a prior frame preceding the current frame to the trained neural network; and
in response to the trained neural network outputting an intermediate color output image and an intermediate opacity output image corresponding to the prior frame, generating the current frame by combining non-hair rendered components of the current frame with a final rendered hair image based on the intermediate color output image and the intermediate opacity output image corresponding to the prior frame.

20. The non-transitory computer-readable storage medium according to claim 19, wherein
the performing the deferred hair rendering further comprises, during rendering of the current frame, generating a color input image and an opacity input image corresponding to the current frame, and
the generated color input image and opacity input image corresponding to the current frame are provided to the trained neural network during rendering of a next frame after the current frame.
